(19) United States
(12) Patent Application Publication
(10) Pub. No.: US 2020/0147479 A1
(43) Pub. Date: May 14, 2020

(54) METHOD OF PLAYING A BINGO GAME

(71) Applicant: Deborah L. LEAKE, Marshall, NC (US)

(72) Inventor: Deborah L. LEAKE, Marshall, NC (US)

(21) Appl. No.: 16/190,662

(22) Filed: Nov. 14, 2018

(51) Int. Cl. A63F 3/06

(52) U.S. Cl. CPC A63F 3/062; G07F 17/329

(57) ABSTRACT

A method of playing a team bingo game includes dividing a group of people into at least two teams wherein each team will play an independent bingo game. Each team selects a captain and the team bingo game begins with each captain utilizing a competition mechanism to determine the amount of bingo balls each team will draw per turn. A team wins the team bingo game when a member of one of the teams achieves a bingo. A person may play a separate bingo game while watching the team bingo game by first choosing a team to play along with. The person will then use that team's bingo balls and attempt to achieve a bingo. The balls selected will be placed in a tier of bingo balls, and the person playing along will be awarded a prize based on which tier of bingo balls their winning bingo ball falls into.

### TECHNICAL FIELD

This invention relates to a method of playing bingo. More particularly, this invention relates to a method of user(s) being able to play bingo at locations remote from the game site, wherein the game site is a bingo game being filmed in front of a live audience. More specifically, this invention relates to a method of playing a bingo game with home viewers/player participation in which the outcomes to the bingo games are not predetermined.

### BACKGROUND ART

Bingo is a game of chance played with different randomly drawn numbers, which players match against numbers that have been pre-printed on 5×5 cards. The cards may be printed on paper or card stock, or electronically represented, and are referred to as bingo cards. Many versions conclude the game when the first person achieves a specified pattern from the drawn numbers. The winner is usually required to call out the word “Bingo”, which alerts the other players and caller of a possible win. All wins are checked to make sure the person has not made a mistake before the win is officially confirmed at which time the prize is secured and a new game is begun. In this version of bingo, players compete against one another for the prize or jackpot.

Alternative methods of play are exploited in an attempt to increase participation by creating excitement. Since its invention in 1929, the game of bingo has evolved into multiple variations, with each jurisdiction's gambling laws regulating how the game is played. There are also nearly unlimited patterns that may be specified for play. Some games require only one number to be matched, while cover-all games award the jackpot for covering an entire card. There are even games that award prizes to players for matching no numbers or achieving no pattern.

Previous attempts at creating a television game show based on the game of bingo with home viewer/player participation have not been successful. In part, this has been because of the technology available at the time and also because most of the operators of the game tried to use one bingo game and one set of bingo game card permutations. Also, these previous bingo based television shows had all of the potential home viewer/players visiting one web site to acquire their bingo cards. In order to determine and control the number of winners, the results of the games were “pre-determined”, and the winning bingo game cards were distributed based on pre-determined outcomes. Although the method of pre-determining the winners was disclosed to the players, it was still perceived as not a real game of bingo.

Thus, there is a need in the art for a method of playing a bingo game wherein nothing is pre-determined and the players, both those playing in the recording studio and those playing from home, are participating in a real game of bingo.

### SUMMARY OF THE INVENTION

It is an object of one aspect of the present invention to provide a method of playing a bingo game between two teams.

It is an object of another aspect of the present invention to provide a method, as above, which can be played before a live audience with the teams being made up of members of the audience.

It is an object of a further aspect of the present invention to provide a method, as above, wherein the game is recorded for television and viewers at home can participate.

It is an object of yet another aspect of the present invention to provide a method, as above, where there are no predetermined outcomes.

It is an object of an additional aspect of the present invention to provide a unique bingo card for use in playing the game according to the method of the present invention.

These and other objects of the present invention, as well as the advantages thereof over existing prior art forms, which will become apparent from the description to follow, are accomplished by the improvements hereinafter described and claimed.

In general, a method of playing a team bingo game according to the present invention includes the steps of dividing a group of people into at least two teams wherein each team will play an independent bingo game; selecting a team captain for each team; beginning the team bingo game by each team captain utilizing a competition mechanism to determine the amount of bingo balls each team will draw per turn; and determining a winner of the team bingo game when a member of one of the teams achieves a bingo.

A method for a person to play a bingo game while watching a team bingo game between at least two teams according to the present invention includes the steps of the person choosing which team from the at least two teams the person will be playing with, the team chosen being the person's chosen team; the person using bingo balls that are selected during the team bingo game for the use of the person's chosen team and attempting to achieve a bingo using the selected bingo balls; creating a tier or tiers of bingo balls associated with the bingo balls drawn for the chosen team; associating a prize with each of the created tiers; recording the winning bingo ball if the person achieves a bingo; and the person winning the prize associated with the tier that the person's winning bingo ball was assigned to.

A customized bingo card according to the present invention includes a traditional bingo card having five vertical rows and five horizontal rows forming a 5×5 matrix; a prize row on an outside edge of the 5×5 matrix; and a blank row on another outside edge of the 5×5 matrix, wherein the blank row is opposite the prize row.

A preferred method of playing a bingo game according to the concepts of the present invention is shown by way of example in the accompanying drawings without attempting to show all the various forms and modifications in which the invention might be embodied, the invention being measured by the appended claims and not by the details of the specification.

### BRIEF DESCRIPTION OF THE DRAWINGS

FIG. 1 depicts an exemplary wheel/spinner used as a competitive mechanism for the in-studio bingo game;

FIG. 2 depicts a customized bingo card;

FIG. 3 depicts the manner in which the called bingo numbers are arranged in a tier/level system;

FIG. 4 depicts a customized bingo card with a pattern play shaped as the letter “T”;

FIG. 5 depicts a customized bingo card with the pattern play shaped as the letter “X”;

FIG. 6 depicts a customized bingo card with a “double box” pattern play; and

FIG. 7 depicts a Super Prize Bingo Bonus customized card showing a highlighted bingo pattern needed to win the Super Prize Bingo Bonus game.

### PREFERRED EMBODIMENTS FOR CARRYING OUT THE INVENTION

In one embodiment of the present invention, there is a bingo game being played in a television studio in front of a live audience, which is either broadcast live or replayed at a later date. This in-studio bingo game is a team concept bingo game which uses two or more teams playing regular bingo games that are independent of one another. The in-studio bingo game will be won when the first player for a respective team achieves a pre-announced bingo pattern and yells out the word “BINGO”. These teams can be distinguished by using a different color, name, symbol, or any other distinction. Each team is playing an independent bingo game using their own bingo hopper, their own bingo cards, and their own set of bingo balls. As a result, the outcomes of the games are unique to each in-studio team.

In one embodiment, the live studio audience is split into two even teams, for example the “red team” and the “blue team”, and one player from each team is selected to represent each team. The selected team representative, or team captain, will first draw a prize envelope from a multitude of prize envelopes. In one embodiment of the present invention, the prize envelope selected by each team captain will only get to be opened by the team captain if their team wins that game of bingo. In another embodiment of the present invention, the prize envelope selected at the beginning of each game of bingo will be opened by the team captain prior to the bingo game beginning. In this embodiment, each team member of each team will be assigned a bingo number prior to the start of the bingo game. If the team captain opens the prize envelope to reveal a “team prize”, then all of the numbers called during that respective bingo game will have a corresponding team member that will received the announced “team prize” if that team members ball is selected.

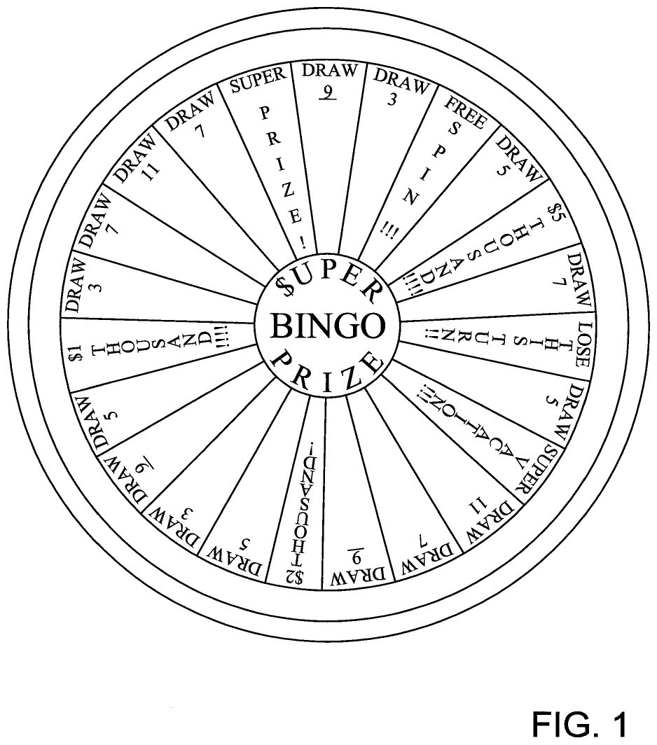

A competition mechanism is used which will determine how many bingo balls can be drawn and called during a team's turn. The competition mechanism may be a wheel/spinner, such as shown in FIG. 1, a customized card deck, dice or other random selector. The competition mechanism may have a prime number set such as 3, 5, 7, and 11 or other sets of numbers that can be used to randomize the number of bingo balls that each team can draw from their hopper.

Once the envelope has been drawn by the team captain, regardless of whether or not the envelope is opened at that time, the respective team captains will then play the competition mechanism versus each other. In one embodiment, a wheel/spinner, as shown in FIG. 1, is the competition mechanism used and the selected team representative will spin the wheel to determine how many balls will be selected for their respective team. Those selected balls will form the pool of numbers from which each team will attempt to achieve a bingo.

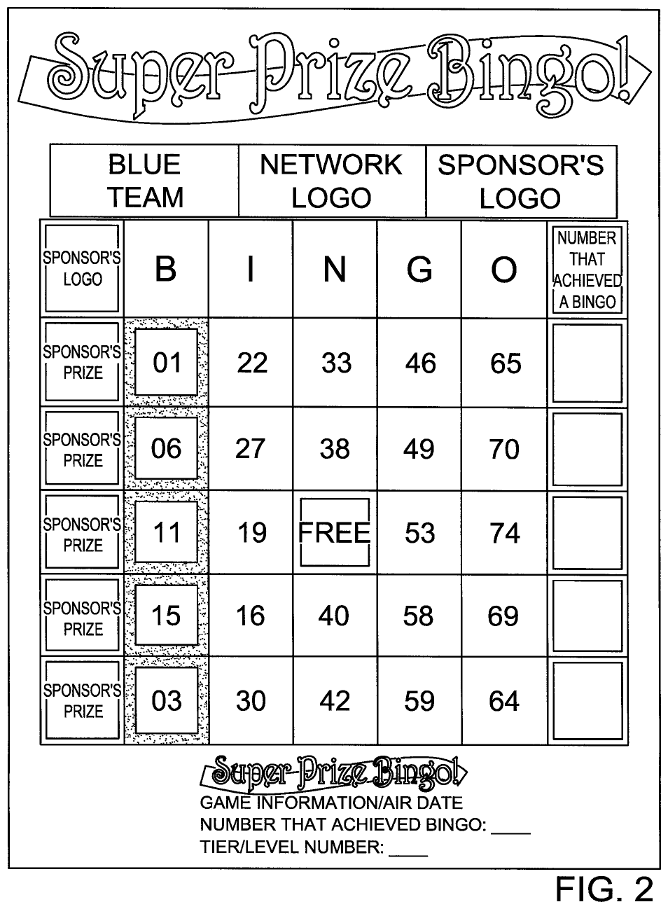

The in-studio audience who is playing along will be playing each game of bingo using a bingo card such as the bingo card shown in FIG. 2. As shown in FIG. 2, this bingo card contains two novel rows positioned outside the traditional 5×5 bingo card. One row is the “Sponsor's Row” and the other row is the “Number that achieved the Bingo Row”. In one embodiment of the present invention, each box of the “Sponsor's Row” will contain a specific prize from a specific sponsor. When an in-studio audience member achieves a bingo, that audience member would then write down the bingo number that achieved the bingo for them in the box in the “Number that achieved the Bingo Row” that corresponded to the position of the winning bingo number. Then, whichever box in the “Sponsor's Row” which positionally lined up with the box in the “Number that achieved the Bingo Row” would determine which prize the audience member would receive for getting a bingo.

Prior to watching the team bingo games, the players playing from home will choose which team they are going to play along with, either the “red team” or the “blue team”. The players acquire that team's bingo cards and they only use the bingo number outcomes from the team that they selected. The bingo cards are customized to each team, and the distribution of these customized cards will be zip code relevant and the players use their selected cards to “play along” using their team's bingo number outcomes.

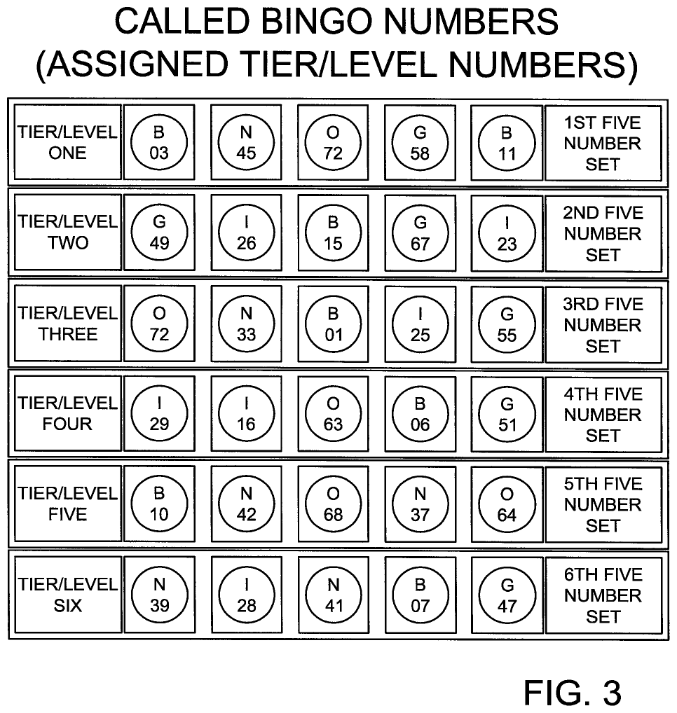

However, the “regular” bingo game style being played by the in-studio teams will not work for the home viewer/players since the in-studio game will award the prize to the first player from either team that achieves a pre-announced bingo pattern. Thus, a different method of awarding bingo prizes must be used for the players playing at home. Customized bingo cards, such as the one shown in FIG. 2, are also used by the home viewer/player. These customized bingo cards have “outer spaces” that display a prize and provides a space for the player to fill in the number that achieved their winning bingo pattern. Although the “Sponsor's Row” will not be used to determine the prize awarded to the home player, the home players will be able to use the “Number that achieved the Bingo Row”. Therefore, in some embodiments, the bingo cards for the at home players may not contain the “Sponsor's Row”. Once the at home player achieves a bingo, they can fill in the number that achieved their winning bingo pattern in the “Number that achieved the Bingo Row”. Then, the home player looks at the “tier/level” number that is associated with that bingo number, as shown in FIG. 3. The tiers/levels are formed by assigning a tier/level number to sets of five bingo numbers, established as the outcomes from the regular bingo game are drawn from each team's bingo hopper. A set of five is an exemplary set, and other sets of bingo numbers, such as eight, seven, four or three could also be used, for example.

To formulate the various tiers/level, the first five numbers drawn during the in-studio bingo game, would be placed in the tier/level one; the second five numbers drawn would be tier/level two, and so forth. Wherein each bingo game, the one being played for the red team and the one being played for the blue team, would have their own unique tiers/levels. A win for a home player is based on the order of the outcomes and what tier/level the winning number was in when the player achieved their bingo, and it is not based on being the first to bingo. This means that a player who achieves a bingo with a tier/level one number is granted a higher valued prize than a player who achieved their bingo with a tier/level two prize, because the player who achieved a bingo using a tier/level one bingo achieved a bingo using a smaller amount of bingo numbers, and should be awarded as such.

For example, the team representative from the blue team would spin the wheel as shown in FIG. 1, and if the wheel landed on a “DRAW 9”, the first 9 bingo balls would be drawn. The first 5 balls drawn (in this example, the first 5 balls would be B03, N45, 072, G58, and B11) would make up the Tier/Level 1, as shown in FIG. 3, and then the next 4 balls drawn (G49, I26, B15, and O67) would be placed in the Tier/Level 2. A player playing from home, who chose to play with the blue team, would then proceed to see if any of the first 9 balls matched any of their squares. In this Example, the player playing from home would be playing the card as shown in FIG. 2, and they would be able to mark off B03, G58, B11, G49, and B15.

Next, the team representative from the red team would spin the wheel as shown in FIG. 1. Then, depending on the number of balls drawn, a separate tier/level system would be set up specifically for the red team, and any player playing from home, who chose to play with the red team, would check their bingo cards accordingly. Next, it would be the blue team's representative's turn to spin the wheel, and back and forth until someone in the studio audience got a bingo, which would end the game for both the players playing at home and those players playing in the studio audience. It would take the at home player playing the card as shown in FIG. 2 until the ball B06, for example, was selected before they got a bingo. As shown in FIG. 3, this would mean that the player playing at home would receive a prize associated with Tier/Level 4, because that is the tier/level in which their winning ball was placed in.

Most bingo card distributors have their own set of tested bingo permutations that they describe as various “series”. Some series may have six thousand unique bingo card game faces and others may have a hundred thousand unique bingo card game faces. Each series of bingo cards are designed to have no repeated game faces and therefore no multiple bingo winners. In order to accommodate the game play of millions of home viewers/players, it is necessary to modify how these series of unique bingo permutations are generated and distributed to the home viewers/players. It is therefore necessary to have a method of playing that does not require the bingo card distributors to change or alter their own bingo permutations, and allow for many different bingo card distributors to be able to be used.

Therefore, the bingo cards will be specific to not only the specific in-studio team selected, but there will also be both sponsor and network specific customizations to achieve a way to use the bingo card distributors tested permutations that are used in regular bingo games. The preferred method of game play in the regular team bingo uses electronic bingo because it is fast and automatically marks the player's cards, alerts them when they have a bingo, and has a tested and approved winner verification system. For the viewers/players, they will have the option of using an electronic platform to play along from home, or they will also have the option of downloading a paper form of the game card from the proper web site.

In order to control the distribution of the game cards, it will be necessary to control and direct the visits to the web site by the viewers/players. Therefore, they will be visiting a network web site and then selecting the site that offers the regular team bingo game, they will register, select a team, and select a sponsor, prize options, and method of play (electronic or paper bingo). The customized bingo cards that are made available are first “team specific”, then “sponsor specific” then “sponsor prize specific” and then “tier/level” specific (determined once the game has been played). The cards are modified to include all of these elements as well as to insure that the bingo game face is one of the bingo card distributor's bingo number permutations.

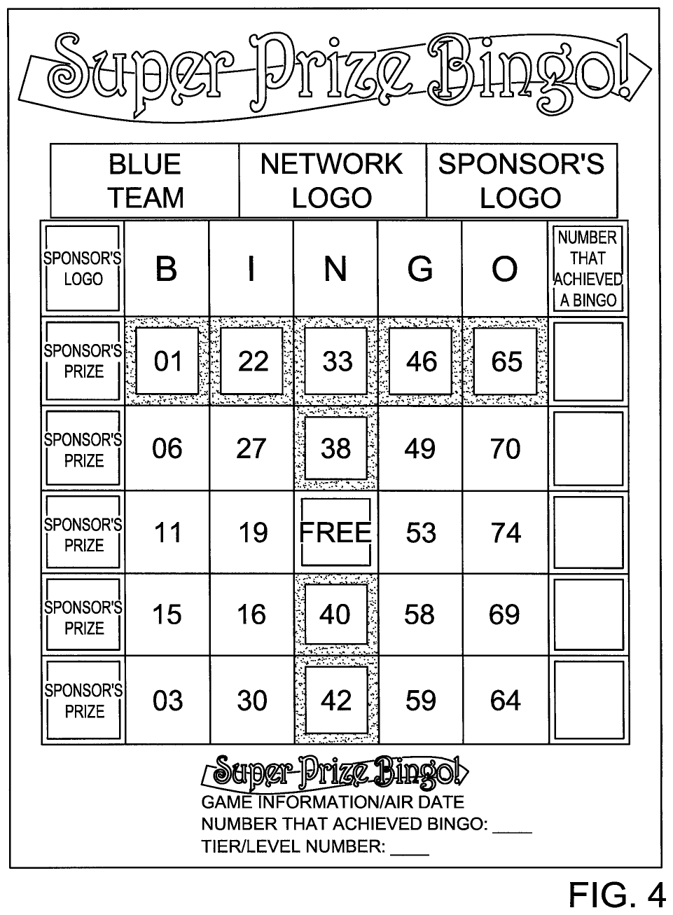

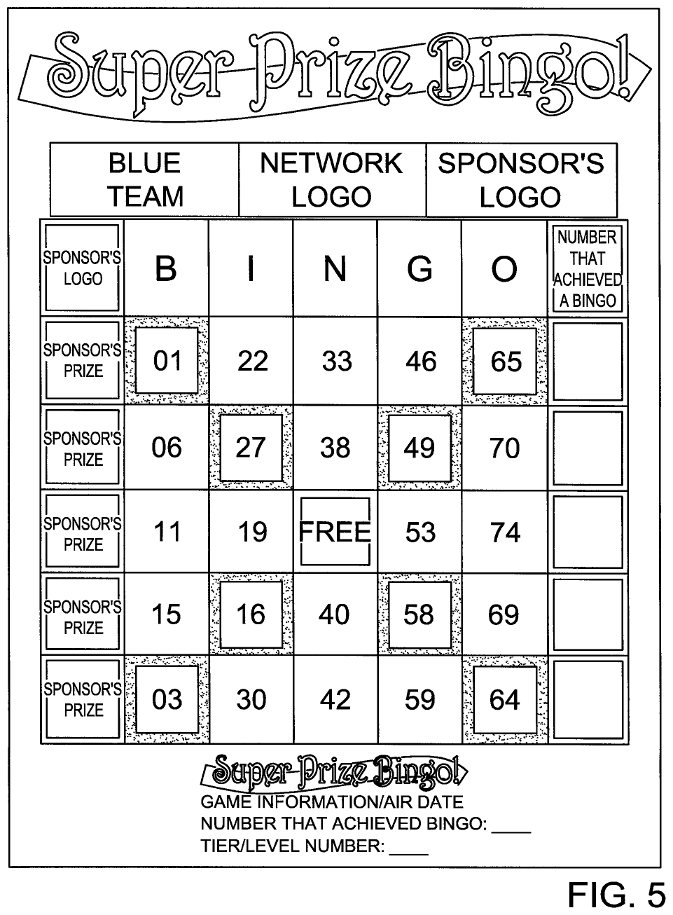

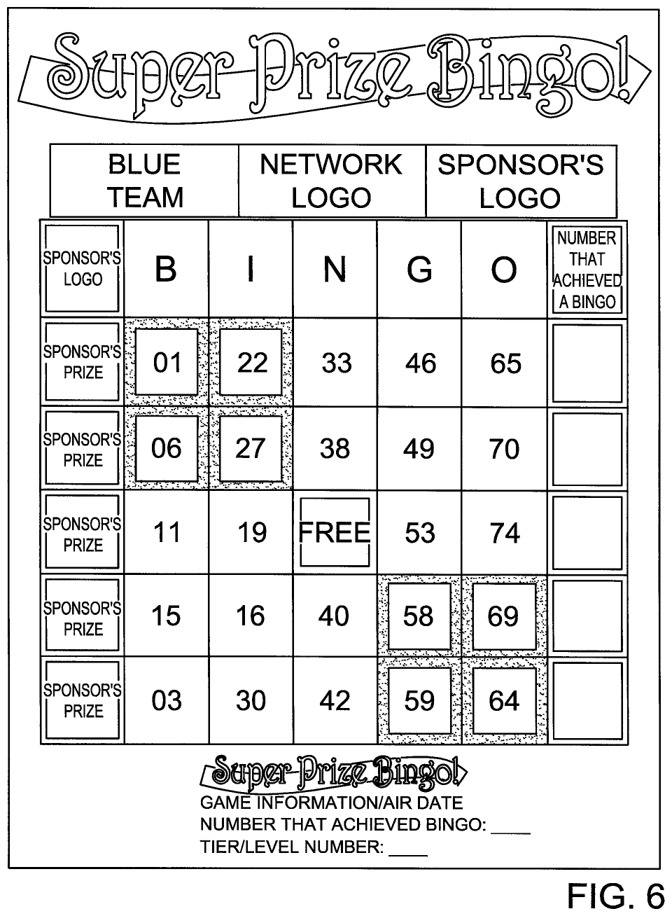

Another manner in which to modify the game is to employ a pattern play system which categorizes the bingo patterns by the number of spaces to be covered to achieve a bingo. Employing a pattern play system will expand the gameplay by allowing the at home participants to play numerous bingo patterns simultaneously instead of having every one of the at home participants playing to achieve the same bingo pattern. Some exemplary patterns that could be used during pattern play bingo are players having to form the letter “T” with their bingo, as shown in FIG. 4, the letter “X” with their bingo, as shown in FIG. 5, and or a “double box” bingo, as shown in FIG. 6.

This format of players being able to play an at home bingo game while watching a live/prerecorded bingo game being played is also amenable to being set up as a “Pay-to-Play” bingo game. A Pay-to-Play bingo game can be run through an online-casino or the game can be played in a manner similar to a state-run lottery game. In either instance, prior to playing, the at home player would register and receive a membership players credit/debit card, and once registered, they would be able to purchase bingo cards to play along at home (as well as pay their applicable taxes electronically so that their winnings can be deposited into their membership account). The at home player would be in essence purchasing a membership to be able to play along at home, receive profit/loss statements, generate and sign tax forms so that their winnings can be deposited and receive participation points and reward credits. The Membership credit/debit cards could be used by charities and non-profit organizations in addition to brick and mortar casinos and social networks.

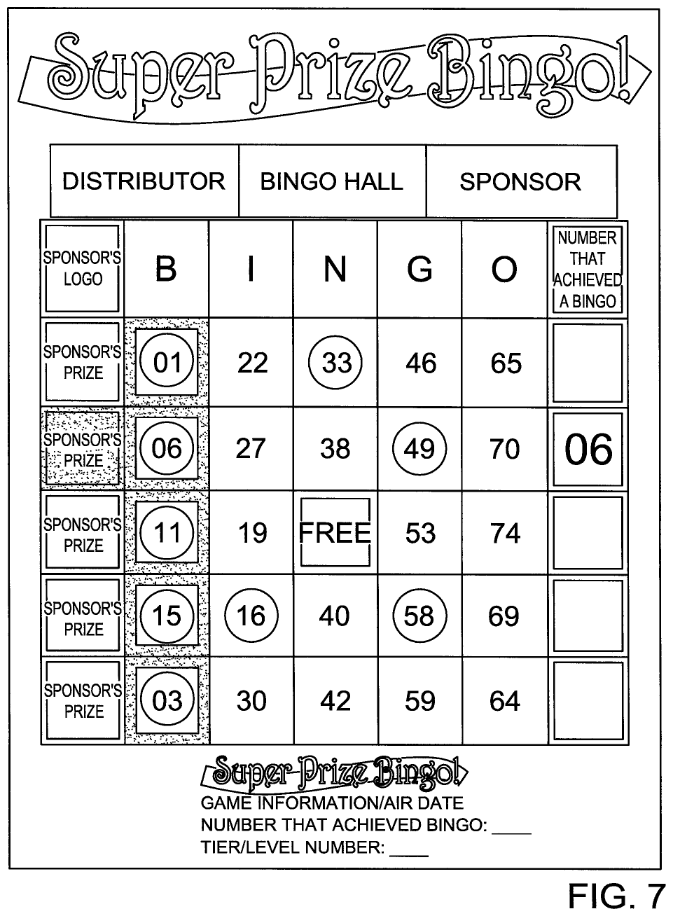

In another embodiment of the present invention, players playing in a bingo hall can play a “Super Prize Bingo Bonus” game. The Super Prize Bingo Bonus game can be played while playing a regular bingo game in a bingo hall or a casino, and can be played with or without playing along with the bingo game being played in the television studio. If the bingo hall player chooses to play the Super Prize Bingo game, they will receive a special bingo card, such as the one shown in FIG. 7. The special bingo card will have a highlighted bingo pattern, meaning that a specific bingo pattern (such as the straight line down all of row B as shown in FIG. 7) will be highlighted in a different color than any other possible bingo pattern, and if during the course of the regular bingo game, the player makes a bingo on the highlighted pattern, they win the Super Prize Bonus. The Super Prize Bonus will be determined based on the bingo number that gave them the bingo. Specifically, prizes will be listed in the row to the left of the B row of the bingo card (the row labeled as “Sponsor's Logo” in FIG. 7) and the bingo number that gave the player a bingo will correlate with a prize located in the corresponding row of the row to the left of the B row. The highlighted bingo pattern can be randomly generated for each card and the card can use a ratio distribution of the prizes located in the row to the left of the B row. This type of prize delivery system can be modified to award a “progressive jackpot” like prize so as to accommodate linked progressive bingo game play.

In light of the foregoing, it should thus be evident that a method of playing bingo as described herein substantially improves the art.

What is claimed is:

1. A method of playing a team bingo game comprising the steps of:
a. dividing a group of people into at least two teams wherein each team will play an independent bingo game;
b. selecting a team captain for each team;
c. beginning the team bingo game by each team captain utilizing a competition mechanism to determine the amount of bingo balls each team will draw per turn; and
d. determining a winner of the team bingo game when a member of one of the teams achieves a bingo.

2. The method of claim 1 wherein the competition mechanism is utilized every turn until a winner is determined.

3. The method of claim 1 wherein the competition mechanism is selected from the group consisting of wheel/spinner, customized card deck, dice or other random selector.

4. The method of claim 1 wherein each team uses their own bingo cards and their own bingo ball hopper wherein each bingo ball hopper produces a unique set of bingo balls from which each team will attempt to achieve a bingo.

5. The method of claim 1 wherein prior to the beginning step, each team captain will draw a prize envelope from a multitude of prize envelopes.

6. The method of claim 5 wherein each team captain will open the prize envelope only if their team wins the bingo game.

7. The method of claim 5 wherein each team captain will open the prize envelope prior to the beginning of the team bingo game.

8. A method for a person to play a bingo game while watching a team bingo game being played between at least two teams comprising the steps of:
a. the person choosing which team from the at least two teams the person will be playing along with, the team chosen being the person's chosen team;
b. the person using bingo balls that are selected during the team bingo game for the use of the person's chosen team and attempting to achieve a bingo using the selected bingo balls;
c. creating a tier or tiers of bingo balls associated with the bingo balls drawn for the chosen team;
d. associating a prize with each of the created tiers;
e. recording the winning bingo ball if the person achieves a bingo; and
f. the person winning the prize associated with the tier that the person's winning bingo ball was assigned to.

9. The method of claim 8 wherein each created tier includes X number of bingo balls drawn for the chosen team and wherein X is selected from the group consisting of 3, 4, 5, 6, 7, or 8 bingo balls.

10. The method of claim 8 wherein the winning bingo ball is the last bingo ball used by the individual person to complete their bingo.

11. The method of claim 8 wherein the team bingo game is played by:
a. dividing a group of people into at least two teams wherein each team will play an independent bingo game;
b. selecting a team captain for each said team;
c. beginning the team bingo game by each team captain utilizing a competition mechanism to determine the amount of bingo balls each team will draw per turn; and
d. determining a winner of the team bingo game when a member of one of the teams achieves a bingo.

12. The method of claim 11 wherein the competition mechanism is utilized every turn until a winner is determined.

13. The method of claim 11 wherein the competition mechanism is selected from the group consisting of wheel/spinner, customized card deck, dice or other random selector.

14. The method of claim 11 wherein each team uses their own bingo cards and their own bingo ball hopper wherein each bingo ball hopper produces a unique set of bingo balls from which each team will attempt to achieve a bingo.

15. The method of claim 12 wherein prior to the beginning step, each said team captain will draw a prize envelope from a multitude of prize envelopes.

16. The method of claim 15 wherein each team captain will open the prize envelope only if their team wins the bingo game.

17. The method of claim 15 wherein each said team captain will open the prize envelope prior to the beginning of the team bingo game.

18. A customized bingo card comprising:
a. a traditional bingo card having five vertical rows and five horizontal rows forming a 5×5 matrix;
b. a prize row on an outside edge of the 5×5 matrix; and
c. a blank row on another outside edge of the 5×5 matrix, wherein the blank row is opposite the prize row.

19. The customized bingo card of claim 18 wherein the prize row contains images of potential prizes that can be won if a user of the customized bingo card achieves a bingo, wherein the blank row is used to fill in the winning bingo number that achieved a bingo for the user of the customized bingo card, and wherein the positioning of the winning bingo number within the blank row corresponds to the position of the winning bingo number within the 5×5 matrix.

20. The customized bingo card of claim 19 wherein the user of the customized bingo card will align their winning bingo number in the blank row with the prize in the prize row that positionally lines up with the position of the winning bingo number within the 5×5 matrix to determine which prize they will receive.
